(19) United States
(12) Patent Application Publication
(10) Pub. No.: US 2006/0150999 A1
(43) Pub. Date: Jul. 13, 2006

(54) Dental plaque-reducing device

(76) Inventor: Sheldon Kneller, Cave Creek, AZ (US)

Correspondence Address: MICHAEL A. SHIPPEY, PH. D., 4848 LAKEVIEW AVENUE, SUITE B, YORBA LINDA, CA, 92886, US

(21) Appl. No.: 11/035,207

(22) Filed: Jan. 13, 2005

(51) Int. Cl. A61C 15/00

(52) U.S. Cl. 132/324

(57) ABSTRACT

The present invention discloses a disposable flossing device made of a soft plastic. It is equipped with a planed edge along the downward edge to be implemented as a plaque-removing pick for sub-gingival tracing along the base of the tooth which aids in the prevention of gum disease and periodontal pockets.

### BACKGROUND OF THE INVENTION

1. Field of the Invention

This invention relates to the field of plaque reducing dental tools used to remove plaque on or between the teeth. More specifically, this invention relates to plaque reducing dental tools utilizing a molded frame and floss incorporated into the body specializing in reducing plaque buildup on and between the teeth.

2. Summary of Related Art

Prior art has encountered difficulty with providing ease of utility in the access and flossing of the rear molars in its embodiments of disposable flossing devices. It is the purpose of the present invention to provide an ease of use not experienced with the flossing devices of prior art, specifically when pertaining to the removal of debris lodged within the spaces between the rear molars. A particularly hard to reach angle is introduced when performing this part of the cleaning process, which is made more easily accessible with the use of the present invention despite the awkward angle which it presents.

Prior art also has difficulty reaching the rear teeth, a problem that could cause tooth decay and in serious cases, the removal of the teeth via oral surgery or worse. The present embodiment is effective in plaque removal by utilizing its small size for maneuverability; its soft plastic for durability, control, and comfort; its planed horizontal edge and sharpened end enabling the use as a toothpick for the removal of plaque on and between the teeth; and its unique shape for mobility and ease of navigation throughout the mouth to reach all teeth easily and painlessly, even for the most inexperienced user.

Prior art has developed many personal dental flossing tools, which are easy to use for flossing the front and middle teeth, but are problematic for reaching the rear teeth. The rear teeth are often the most neglected teeth because they are the hardest to access and floss. This often results in tooth decay and eventually the removal of such teeth, via oral surgery, especially the wisdom teeth. If the tooth is badly impacted, oral surgery is often complicated and much more painful with the need for additional measures, such as breaking the tooth in pieces before extracting, and the administering of additional pain medication.

The preferred embodiment of the present invention utilizes a large, broad base consisting of a soft, flexible plastic shaped to stabilize the unit for use inside the mouth to attain proper flossing of the rear teeth such as the rear molars and wisdom teeth. The present embodiment utilizes a unique, closed C-shaped end that enables it to reach the rear teeth with greater ease than prior art has been able to attain. The present embodiment is small enough to maneuver around the mouth and get access to the often-problematic rear teeth, such as the rear molars and wisdom teeth. The soft plastic body is instrumental in creating a long-lasting tool that is soft on the gums resulting in little or no discomfort for the user.

The small size and broad base of the present embodiment allows for ease of maneuvering the tool inside of the mouth to reach all the teeth, especially the rear molars and wisdom (if applicable), easily and effectively. The small size of the present embodiment also ensures complete mobility in the mouth to reach all the teeth, especially the rear molars and the wisdom (if applicable) with ease. Soft plastic is utilized throughout the present embodiment to ensure the safety and comfort of the user in the event of slippage, in which competing designs could potentially cause discomfort or bleeding if not careful.

### SUMMARY OF THE INVENTION

The preferred embodiment of the present invention introduces a disposable flossing device made of a softer plastic than that of prior art and equipped with a planed edge along the downward edge to be implemented as a plaque-removing pick for sub-gingival tracing along the base of the tooth which aids in the prevention of gum disease and periodontal pockets.

It is the purpose of the present invention to provide an ease of use not experienced with the flossing devices of prior art, specifically when pertaining to the removal of debris lodged within the spaces between the rear molars. A particularly hard to reach angle is introduced when performing this part of the cleaning process, which is made more easily accessible with the use of the present invention despite the awkward angle which it presents.

A further advantage of the present invention is the broad grip on the handle that enables the user to retain a firmer grasp on the flossing device, preventing slippage that could potentially cause harm, discomfort, and even bleeding along the sensitive gum line. This also facilitates a more precise motion while accessing the rear of the mouth to remove calcified plaque from along the gum line of the back molars.

### BRIEF DESCRIPTION OF THE DRAWINGS

FIG. 1: A side view of the present embodiment as it is to be inserted into the mouth of the user.

FIG. 2: A side view of the present embodiment as it is to be inserted into the mouth of the user showing an alternative design utilizing more sides with differing angles to achieve the same results.

### DETAILED DESCRIPTION OF THE DRAWINGS

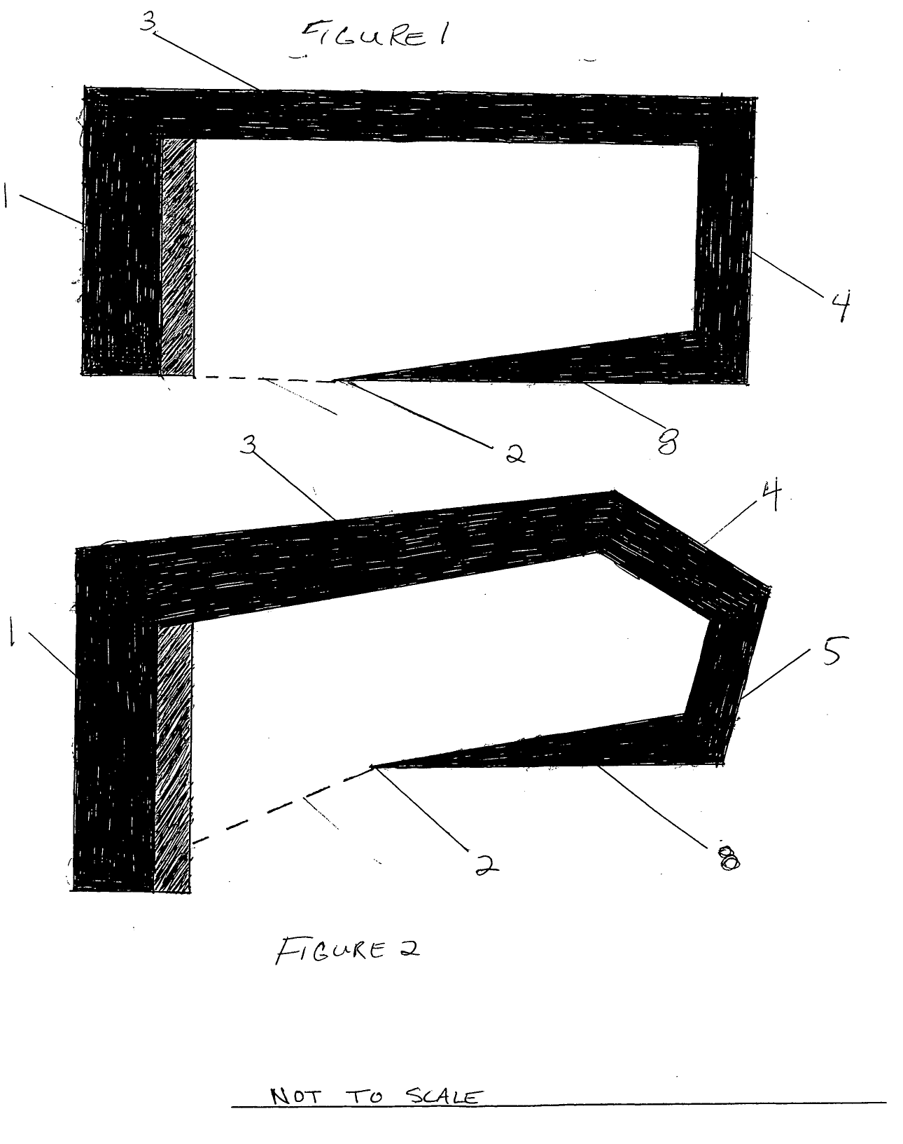

FIG. 1: A side-view of the present embodiment showing the large, broad base 1 consisting of a soft, flexible plastic shaped to stabilize the unit for use inside the mouth to attain proper flossing of the rear teeth such as the rear molars and wisdom teeth. This feature prevents slippage that could potentially cause harm, discomfort, and even bleeding along the sensitive gum line. This also facilitates a more precise motion while accessing the rear of the mouth to remove calcified plaque from along the gum line of the back molars. The present embodiment also shows the horizontal, much longer piece of the tool 3, which allows for reaching the rear teeth with ease. The vertical side 4, opposite the base 1, maintains the same dimensions as the base 1 and connects to the final horizontal side 8 leading to a pointed, planed edge 2 allowing the implementation as a plaque-removing pick for sub-gingival tracing along the base of the tooth which aids in the prevention of gum disease and periodontal pockets. The small size of the present embodiment allows for ease of maneuvering tool inside of the mouth to reach all the teeth, especially the rear molars and wisdom, easily and effectively. The soft, plastic body 1,2,3,4,8 is instrumental in creating a long-lasting tool that repels most common breakage and dental discomfort by being pliable and soft on the gums resulting in little or no discomfort for the user.

FIG. 2: A side-view of the present embodiment showing an alternative design utilizing more sides with differing angles to achieve the same results. The large, broad base 1 consists of a soft, flexible plastic shaped to stabilize the unit for use inside the mouth to attain proper flossing of the rear teeth such as the rear molars and wisdom teeth. This feature prevents slippage that could potentially cause harm, discomfort, and even bleeding along the sensitive gum line. This also facilitates a more precise motion while accessing the rear of the mouth to remove calcified plaque from along the gum line of the back molars. This alternative design of the present embodiment differs in angle and length as well as number of sides 1,2,3,4,5,8 from this point on, displaying 5 sides as opposed to 4 in FIG. 1. The present embodiment utilizes a more curved shape 3,4,5,8 employing 1 extra side 4 or 5 to obtain this curve. This may help in the mobility of the present invention in the most difficult-to-reach areas of the mouth. This curvature connects to final, horizontal side 8 leading to a pointed, planed edge 2 allowing the implementation as a plaque-removing pick for sub-gingival tracing along the base of the tooth which aids in the prevention of gum disease and periodontal pockets. The small size of the present embodiment allows for ease of maneuvering tool inside of the mouth to reach all the teeth, especially the rear molars and wisdom, easily and effectively. The soft, plastic body 1,2,3,4,5,8 is instrumental in creating a long-lasting tool that repels most common breakage by being pliable and soft on the gums resulting in little or no discomfort for the user.

I claim:

1. A device for the flossing of teeth, said device comprising:
an elongated basal arm;
a storage arm attached at one end of said basal arm, and extending at a right angle outward therefrom;
a support arm, attached at the opposite end of said basal arm, and extending at a right angle outward therefrom;
a floss take-up arm, attached to said support arm at the opposite end from said support arm's origin at said basal arm, and extending at right angles therefrom in the direction of said storage arm;
said floss take-up arm tapering from a widest point at the attachment to said support am, to a narrow point at its free end; and,
a strand of dental floss.

2. The flossing device of claim 1, wherein a strand of floss runs from an exit port near the free end of said storage arm, to the narrow point at the free end of the floss take-up arm.

3. The flossing device of claim 1, wherein said arms are constructed of soft, pliable material.

4. The flossing device of claim 1, wherein the distance between the free end of said floss take-up arm to the free end of said storage arm is between 10 mm and 60 mm.

5. The flossing device of claim 1, wherein said device is made from non-toxic plastic, apart from the strand of dental floss.

6. The use of the device of claim 1 to clean between one's teeth by using the device as a tool for flossing.
